(19) United States
(12) Patent Application Publication
(10) Pub. No.: US 2023/0146596 A1
(43) Pub. Date: May 11, 2023

(54) Method and Apparatus for Automatically Downloading Map Tile, Device and Storage Medium

(71) Applicant: Apollo Intelligent Connectivity (Beijing) Technology Co., Ltd., Beijing (CN)

(72) Inventor: Jie TANG, Beijing (CN)

(21) Appl. No.: 18/154,281

(22) Filed: Jan. 13, 2023

(30) Foreign Application Priority Data
Jun. 24, 2022 (CN) 202210730555.6

(51) Int. Cl. G06F 16/29; H04L 67/06

(52) U.S. Cl. CPC G06F 16/29; H04L 67/06

(57) ABSTRACT

A method and apparatus for automatically downloading a map tile are disclosed. The method includes: determining, in response to determining that a user operates a pre-deployed offline map, a target map tile in the operation process; judging whether data of the target map tile has been downloaded; and creating a folder based on attribute information of the target map tile, if the data has not been downloaded, and downloading the data of the target map tile automatically to the folder.

### CROSS-REFERENCE TO RELATED APPLICATIONS

The present application claims the priority to Chinese Patent Application No. 202210730555.6, titled “Method and Apparatus for Automatically Downloading Map Tile, Device, and Storage Medium,” filed on Jun. 24, 2022, the content of which is incorporated herein by reference in its entirety.

### TECHNICAL FIELD

The present disclosure relates to the technical field of intelligent transportation, and in particular, to a method and apparatus for automatically downloading a map tile, a device and a storage medium.

### BACKGROUND

At present, maps contain more and more rich content and a wider range, and are commonly used in WebGIS (Web Geographic Information System). Every time a front end requests a map, a server needs to generate the map, resulting in large pressure on the server and slow outputting of the map.

A map tile is a map tile file that contains a series of scales and a certain map range. Map tiles are organized in a pyramid structure, and each map tile may be uniquely marked by level, row and column number. When a project needs to be deployed locally and cannot access an external network, it is necessary to download required map tiles and related toolkits locally for local browser access.

### SUMMARY

The present disclosure provides a method and apparatus for automatically downloading a map tile, a device and a storage medium.

According to a first aspect of the disclosure, a method for automatically downloading a map tile is provided. The method includes: determining, in response to determining that a user operates a pre-deployed offline map, a target map tile in an operation process; judging whether data of the target map tile has been downloaded; and creating a folder based on attribute information of the target map tile, in response to determining that the data has not been downloaded, and downloading the data of the target map tile automatically to the folder.

According to a second aspect of the disclosure, an apparatus for automatically downloading a map tile is provided. The apparatus includes: a determining module, configured to determine, in response to determining that a user operates a pre-deployed offline map, a target map tile in an operation process; a judging module, configured to judge whether data of the target map tile has been downloaded; and a downloading module, configured to create a folder based on attribute information of the target map tile, in response to determining that the data has not been downloaded, and download the data of the target map tile automatically to the folder.

According to a third aspect of the disclosure, an electronic device is provided. The electronic device includes at least one processor; and a memory communicatively connected to the at least one processor. The memory stores instructions executable by the at least one processor, and the instructions, when executed by the at least one processor, cause the at least one processor to perform the method of any implementation according to the first aspect.

According to a fourth aspect of the disclosure, a non-transitory computer readable storage medium storing computer instructions is provided. The computer instructions are used to cause the computer to perform the method of any implementation according to the first aspect.

It should be understood that the content described in this part is not intended to identify key or important features of the embodiments of the present disclosure, and is not used to limit the scope of the present disclosure. Other features of the present disclosure will be easily understood through the following description.

### BRIEF DESCRIPTION OF THE DRAWINGS

The accompanying drawings are used for better understanding of the present solution, and do not constitute a limitation to the present disclosure.

FIG. 1 is an exemplary system architecture diagram to which embodiments of the present disclosure may be applied;

FIG. 2 is a flowchart of a method for automatically downloading a map tile according to an embodiment of the present disclosure;

FIG. 3 is a flowchart of the method for automatically downloading a map tile according to another embodiment of the present disclosure;

FIG. 4 is an application scenario diagram of the method for automatically downloading a map tile according to an embodiment of the present disclosure;

FIG. 5 is a schematic structural diagram of an apparatus for automatically downloading a map tile according to an embodiment of the present disclosure; and

FIG. 6 is a block diagram of an electronic device used to implement the method for automatically downloading a map tile according to embodiments of the present disclosure.

### DETAILED DESCRIPTION

Exemplary embodiments of the present disclosure are described below with reference to the accompanying drawings, where various details of the embodiments of the present disclosure are included to facilitate understanding, and should be considered merely as exemplary. Therefore, those of ordinary skills in the art should realize that various changes and modifications can be made to the embodiments described herein without departing from the scope and spirit of the present disclosure. Similarly, for clearness and conciseness, descriptions of well-known functions and structures are omitted in the following description.

It should be noted that the embodiments of the present disclosure and features in the embodiments may be combined with each other on a non-conflict basis. The present disclosure will be described in detail with reference to the accompanying drawings and in conjunction with the embodiments.

FIG. 1 shows an exemplary system architecture 100 to which embodiments of a method for automatically downloading a map tile or an apparatus for automatically downloading a map tile of the present disclosure may be applied.

As shown in FIG. 1, the system architecture 100 may include terminal devices 101, 102, and 103, a network 104, and a server 105. The network 104 serves as a medium providing a communication link between the terminal devices 101, 102, 103, and the server 105. The network 104 may include various types of connections, such as wired or wireless communication links, or optical cables.

A user may use the terminal devices 101, 102, 103 to interact with the server 105 via the network 104 to receive or send information, or the like. Various client applications may be installed on the terminal devices 101, 102 and 103.

The terminal devices 101, 102, 103 may be hardware or software. When the terminal devices 101, 102, 103 are hardware, they may be various electronic devices, including but not limited to smart phones, tablet computers, laptop computers, desktop computers, or the like. When the terminal devices 101, 102, 103 are software, they may be installed in the above electronic devices. The terminal devices 101, 102, 103 may be implemented as a plurality of software or software modules, or may be implemented as a single software or software module, which is no limited herein.

The server 105 may provide various services. For example, the server 105 may analyze and process a target map tile acquired from the terminal devices 101, 102 and 103, and generate a processing result (e.g., automatically downloading data of the target map tile to a folder).

It should be noted that the server 105 may be hardware or software. When the server 105 is hardware, it may be implemented as a distributed server cluster composed of a plurality of servers, or may be implemented as a single server. When the server 105 is software, it may be implemented as a plurality of software or software modules (for example, for providing distributed services), or may be implemented as a single software or software module, which is not limited herein.

It should also be noted that the method for automatically downloading a map tile provided by embodiments of the present disclosure is generally performed by the server 105, accordingly, the apparatus for automatically downloading a map tile is generally provided in the server 105.

It should be understood that the numbers of terminal devices, networks, and servers in FIG. 1 are merely illustrative. Any number of terminal devices, networks, and servers may be provided according to implementation needs.

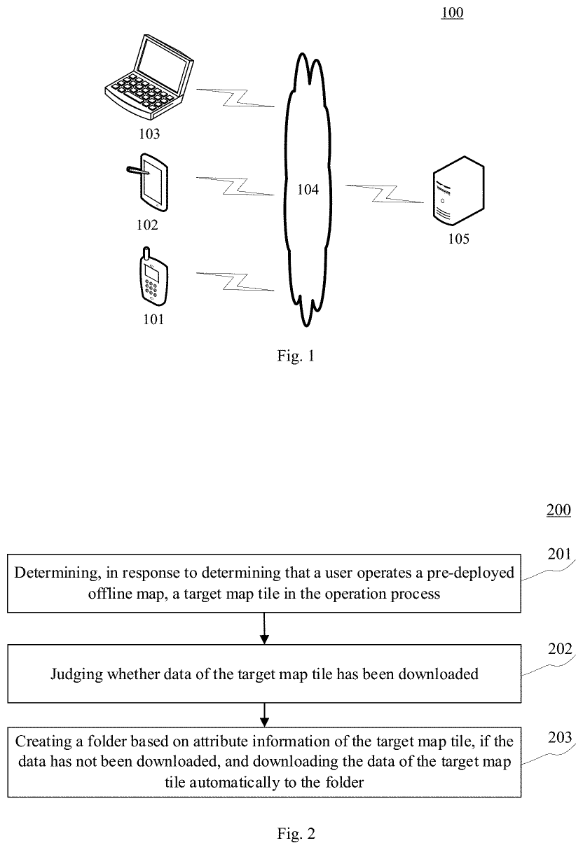

With further reference to FIG. 2, illustrating a flow 200 of an embodiment of a method for automatically downloading a map tile according to the present disclosure. The method for automatically downloading a map tile includes the following steps.

Step 201, determining, in response to determining that a user operates a pre-deployed offline map, a target map tile in the operation process.

In the present embodiment, an executing body of the method for automatically downloading a map tile (for example, the server 105 shown in FIG. 1) may determine the map tile in the operation process by the user, in the case of determining that the user operates the pre-deployed offline map, and use the map tile as the target map tile. The operation here may be dragging and pulling, dragging, or the like. Here, a map monitoring event is generally used to monitor whether the user operate the pre-deployed offline map. For example, a dragend event is used for monitoring. The dragend event is triggered when the user finishes dragging an element or preferred text, that is, the dragend event occurs when the user presses a mouse button and starts moving a mouse on the pre-deployed offline map until the dragging stops. The executing body may determine a map tile in a dragging and pulling process by the user based on the map monitoring event, and use the map tile as the target map tile. Generally, the executing body may determine coordinate information in the dragging and pulling process by the user based on the map monitoring event, the coordinate information including abscissa and ordinate, and the executing body may also determine level information of the map tile in the dragging and pulling process by the user, so that the target map tile may be determined based on the coordinate information and the level information.

Here, the executing body generally may pre-deploy the offline map. For example, a map code may first be downloaded to the local, and the downloaded map code is locally configured, such as changing an online dependency toolkit to a local toolkit, or changing loading an online map tile to loading a local map tile.

Step 202, judging whether data of the target map tile has been downloaded.

In the present embodiment, after determining the target map tile, the executing body may judge whether the data of the target map tile has been downloaded. Since each map tile has a corresponding folder to store corresponding data, the executing body may first judge whether there is a folder of the target map tile. If there is the folder of the target map tile, the executing body may continue to judge whether the data of the map tile is already in the folder, and if yes, it proves that the data of the target map tile has been downloaded. In normal circumstances, if the number of target map tiles to be downloaded is multiple, the executing body may continue to judge a next target map tile; or if the data of the target map tile has not been downloaded, the data of the target map tile may be downloaded automatically.

Step 203, creating a folder based on attribute information of the target map tile, in response to determining that the data has not been downloaded, and downloading the data of the target map tile automatically to the folder.

In the present embodiment, if it is determined that the data of the target map tile has not been downloaded, the executing body may create the folder based on the attribute information of the target map tile, and download the data of the target map tile automatically to the folder. The attribute information here generally refers to the level information, a scaling ratio, etc. of the map tile. Since the map tile is based on a tile, and the tile itself is raster data, it is impossible to continuously scale the map tile without losing metadata. Therefore, the map tile generally realizes level scaling of the map tile by defining a scaling level. Generally, the map tile defines the scaling level in a range of 1 to 20. Therefore, even if maps of the same area have different level information due to the different scaling ratios, each piece of level information corresponds to a map tile.

Therefore, the executing body may create the folder for storing the data of the target map tile based on the level information of the map tile and the current scaling ratio in the operation process by the user, and download the data of the target map tile automatically to the folder after the folder is created.

The method for automatically downloading a map tile provided by embodiments of the present disclosure, first determines a target map tile in the operation process, in response to determining that a user operates a pre-deployed offline map; then determines whether data of the target map tile has been downloaded; and finally creates a folder based on attribute information of the target map tile, if the data has not been downloaded, and downloads the data of the target map tile automatically to the folder. The method for automatically downloading a map tile in the present embodiment, may automatically download the data of the target map tile in the process of dragging and pulling the pre-deployed offline map by the user, thereby improving a download efficiency, and also avoiding problems such as data loss and data abnormality in a process of manually downloading data.

In the technical solution of the present disclosure, the collection, storage, use, processing, transmission, provision, and disclosure of the user personal information involved are all in compliance with the relevant laws and regulations, and do not violate public order and good customs.

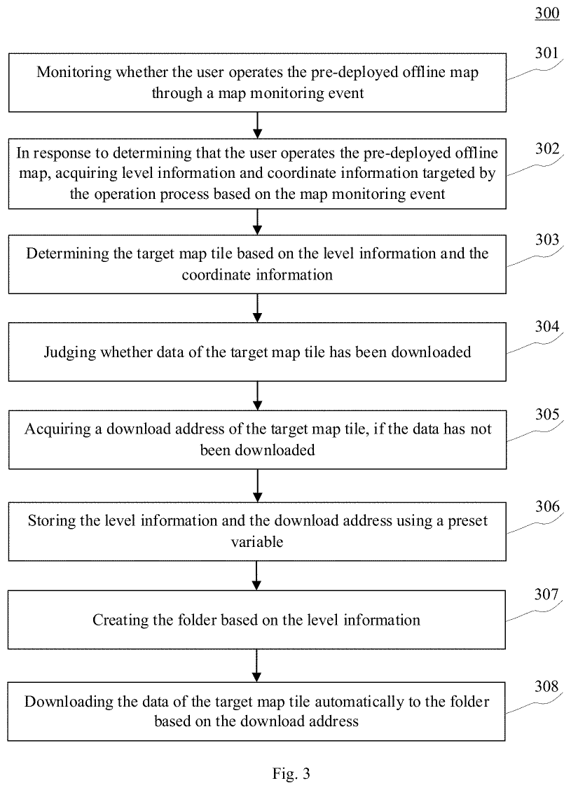

With further reference to FIG. 3, illustrating a flow 300 of another embodiment of the method for automatically downloading a map tile according to the present disclosure. The method for automatically downloading a map tile includes the following steps.

Step 301, monitoring whether the user operates the pre-deployed offline map through a map monitoring event.

In the present embodiment, an executing body of the method for automatically downloading a map tile (for example, the server 105 shown in FIG. 1) may monitor whether the user operates the pre-deployed offline map through the map monitoring event. The map monitoring event here is generally a dragend event. The dragend event is triggered when the user finishes dragging an element or preferred text, that is, the dragend event occurs when the user presses a mouse button and starts moving a mouse on the pre-deployed offline map until the dragging stops. The executing body may determine a map tile in a dragging and pulling process by the user based on the map monitoring event, and use the map tile as the target map tile. Generally, the executing body may determine coordinate information in the dragging and pulling process by the user based on the map monitoring event, the coordinate information including abscissa and ordinate, the executing body may also determine level information of the map tile in the dragging and pulling process by the user, so that the target map tile may be determined based on the coordinate information and the level information. Through the map monitoring event, the user's operation process can be discovered in time, and the map tile information in the operation process by the user can be acquired.

In some alternative implementations of the present embodiment, the offline map is obtained by deploying through steps as follows: acquiring data of the offline map; and in response to receiving configuration information, locally configuring the data of the offline map based on the configuration information.

In this implementation, the executing body may first acquire the data of the offline map. For example, a map code may be downloaded from an official website. Generally, a code of the latest compressed version of the map may be acquired through an address pointed to by a src attribute in a script on a webpage. The map here may be a Baidu map, of course, may alternatively be another map, which is not limited in the present embodiment. However, the code downloaded in this method is compressed code, which is not easy to read. In order to make some modifications in a source code later, formatting may be performed before downloading the code for subsequent viewing and modification.

Then, after receiving the configuration information of the user, the executing body may locally configure the data of the offline map based on the received configuration information. For example, first, where masked AK (Access Key) verification is required is located and confirmed by looking for keywords, such as an onreadystatechange keyword; or a generated AK verification code may be used to locate and search through preset keywords, and then perform assignment operations, such as a BMAP_AUTHENTIC_KEY keyword. Then, dependency online toolkits, dependency online map tiles, etc. in the data of the offline map may be modified to local addresses to complete the localization configuration.

Through the above steps, the offline map may be deployed, so that map tiles may be automatically downloaded based on the offline map.

In some alternative implementations of the present embodiment, the locally configuring the data of the offline map based on the configuration information, includes: locating a dependency toolkit of the offline map based on a first preset keyword in the configuration information, and downloading the dependency toolkit; and locating a dependency map tile of the offline map based on a second preset keyword in the configuration information, and modifying an address of the dependency map tile.

In this implementation, the executing body may locate the dependency toolkit of the offline map based on the first preset keyword in the received configuration information. These toolkits are generally invoked external toolkits (such as toolkits of various types of coatings, markers, and controls). The first preset keyword is generally a map keyword, that is, the executing body may use the map keyword to locate positions of the toolkits, download these toolkits, and name the to-be-downloaded toolkits in the form of key-value.

In addition, the executing body may further locate the dependency map tile of the offline map based on the second preset keyword in the received configuration information, and modify the address of the dependency map tile. The second preset keyword may be getTilesUrl and vtile keywords. That is, the executing body may locate to a corresponding position based on the keywords getTilesUrl and vtile, thereby changing an address for loading an online tile to an address for loading a local tile. In order to facilitate automatic download of the map tile later, it is necessary to save the online tile address here. A custom global variable window.urlArr may be used here to save the address.

Through the above steps, the localization configuration operation on the offline map may be completed, so as to facilitate subsequent automatic download of the map tile.

Alternatively, if it is desired to customize a style of the offline map, the corresponding position may be located based on the keywords getTilesUrl and customimage/tile, and the address for loading an online tile may be changed to the address for loading a local tile. In order to facilitate automatic download of the tile later, it is necessary to save the online tile address here. The custom global variable window.customUrlArr may be used here to save the address. That is, in the present embodiment, customizing the style of the offline map is also supported, so as to meet needs of different users.

Step 302, in response to determining that the user operates the pre-deployed offline map, acquiring level information and coordinate information targeted by the operation process based on the map monitoring event.

In the present embodiment, in the case where it is determined that the user operates the pre-deployed offline map, the executing body may acquire the level information and the coordinate information targeted in the operation process by the user based on the map monitoring event. That is, the executing body may determine the coordinate information in the dragging and pulling process by the user based on the map monitoring event, the coordinate information including abscissa and ordinate, and the executing body may also determine the level information of the map tile in the dragging and pulling process by the user.

Step 303, determining the target map tile based on the level information and the coordinate information.

In the present embodiment, the executing body may determine the target map tile based on the level information and the coordinate information. Since an area and level information corresponding to each map tile are different, after determining the level information and the coordinate information, the executing body may determine the target map tile corresponding to the level information and the coordinate information, so as to determine the map tile operated by the user accurately and quickly.

Step 304, judging whether data of the target map tile has been downloaded.

In the present embodiment, the executing body may judge whether the data of the target map tile has been downloaded. Step 304 is basically the same as step 202 in the foregoing embodiment. For a specific implementation, reference may be made to the foregoing description of step 202, and detailed description thereof will be omitted.

Step 305, acquiring a download address of the target map tile, if the data has not been downloaded.

In the present embodiment, if the data of the target map tile has not been downloaded, the executing body may acquire the download address of the target map tile. That is, acquiring an online address of the target map tile.

Step 306, storing the level information and the download address using a preset variable.

In the present embodiment, the executing body may store the level information and the download address of the target map tile using the preset variable. For example, the custom global variable window.urlArr may be used to store the level information and the download address of the target map tile.

Step 307, creating the folder based on the level information.

In the present embodiment, the executing body may create the folder based on the level information. Here, the folder is a folder where the downloaded data of the target map tile is stored. Since there are a large number of map tiles, and the level information of each map tile is different, the folder for storing is generally created based on the level information of the target map tile, so as to realize an orderly management of the downloaded data.

Step 308, downloading the data of the target map tile automatically to the folder based on the download address.

In the present embodiment, the executing body may download the data of the target map tile automatically to the folder created in step 307 based on the stored download address. Since the online download address of the target map tile has been stored in the custom global variable, the executing body may download the data of the target map tile automatically to the folder created in step 307 based on the download address, so as to realize automatic download of the target map tile.

As can be seen from FIG. 3, compared with the embodiment corresponding to FIG. 2, the method for automatically downloading a map tile in the present embodiment may download the dependency toolkit of the offline map based on the configuration information, avoiding possible problems such as data loss or data abnormality in a process of manually downloading data. In addition, this method may create the corresponding level folder locally based on the level and a range of the map tile, and automatically download the map tile to the corresponding folder, which saves the time cost required for downloading. Finally, this method may also support a custom map style, so that a corresponding map tile may be downloaded according to the user-customized map style, which may meet the needs of different users.

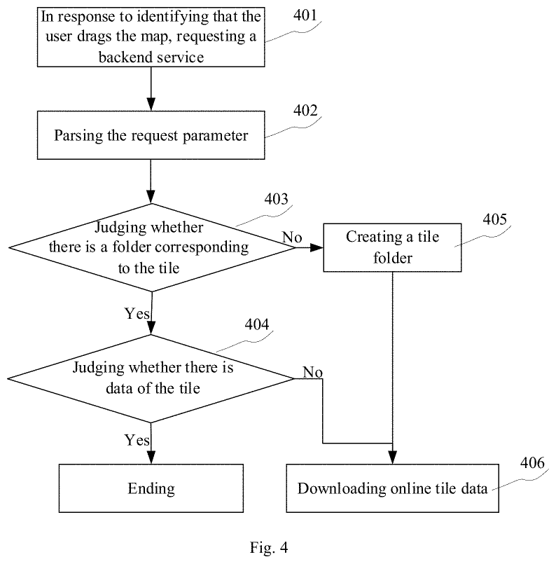

With further reference to FIG. 4, illustrating an application scenario diagram of the method for automatically downloading a map tile according to the present disclosure. In this application scenario, an executing body may first display a Baidu map through a browser, and a user may operate the Baidu map, such as dragging and pulling, dragging, then perform the following steps.

Step 401, in response to identifying that the user drags the map, requesting a backend service. The executing body monitors the user's start of dragging the map through a map monitoring event, saves map tile information in the map dragging process by the user, and requests the backend service when the user finishes dragging the map, where a request parameter includes the map tile information.

Step 402, parsing, by the backend service, the request parameter to acquire the map tile information, such as level information, or a download address.

Step 403, judging whether there is a folder corresponding to the map tile. If there is the folder corresponding to the map tile, then performing step 404; or if there is no folder corresponding to the map tile, then performing step 405.

Step 404, judging whether there is data of the map tile in the folder. If yes, it proves that the data of the map tile has been downloaded, and the request ends; otherwise, performing step 406.

Step 405, creating a tile folder. If there is no folder corresponding to the map tile, the executing body creates the folder corresponding to the map tile based on the level information of the map tile.

Step 406, downloading online tile data. The executing body automatically downloads the data of the map tile to the folder based on the download address of the map tile, thereby realizing automatic downloading of the map tile.

After disconnecting from the network, the user may request offline resources. The offline resources include but are not limited to: static map JS (JavaScript) API (Application Programming Interface), static images, module JS files, static tiles, etc., and may be used to display the offline map for the user.

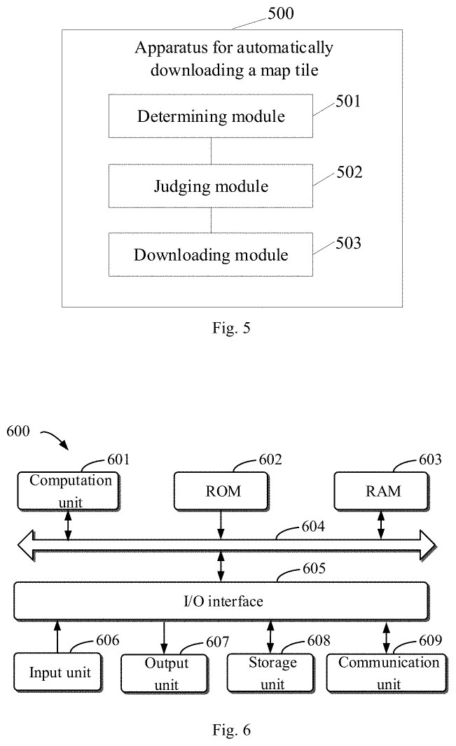

With further reference to FIG. 5, as an implementation of the method shown in the above figures, an embodiment of the present disclosure provides an apparatus for automatically downloading a map tile, and the apparatus embodiment corresponds to the method embodiment shown in FIG. 2. The apparatus may be applied to various electronic devices.

As shown in FIG. 5, the apparatus 500 for automatically downloading a map tile in the present embodiment includes: a determining module 501, a judging module 502 and a downloading module 503. The determining module 501 is configured to determine, in response to determining that a user operates a pre-deployed offline map, a target map tile in the operation process. The judging module 502 is configured to judge whether data of the target map tile has been downloaded. The downloading module 503 is configured to create a folder based on attribute information of the target map tile, in response to determining that the data has not been downloaded, and download the data of the target map tile automatically to the folder.

In the present embodiment, in the apparatus 500 for automatically downloading a map tile, for the specific processing and the technical effects of the determining module 501, the judging module 502 and the downloading module 503, reference may be made to the relevant descriptions of steps 201-203 in the corresponding embodiment of FIG. 2 respectively, and detailed description thereof will be omitted.

In some alternative implementations of the present embodiment, the apparatus 500 for automatically downloading a map tile further includes: a monitoring module, configured to monitor whether the user operates the pre-deployed offline map through a map monitoring event.

In some alternative implementations of the present embodiment, the determining module includes: a first acquiring submodule, configured to acquire level information and coordinate information targeted by the operation process based on the map monitoring event; and a determining submodule, configured to determine the target map tile based on the level information and the coordinate information.

In some alternative implementations of the present embodiment, the apparatus 500 for automatically downloading a map tile further includes: an acquiring module, configured to acquire a download address of the target map tile; and the downloading module includes: a storing submodule, configured to store the level information and the download address using a preset variable; a creating submodule, configured to create the folder based on the level information; and a downloading submodule, configured to download the data of the target map tile automatically to the folder based on the download address.

In some alternative implementations of the present embodiment, the apparatus 500 for automatically downloading a map tile further includes: a deploying module, configured to deploy the offline map, where the deploying module includes: a second acquiring submodule, configured to acquire data of the offline map; and a configuring submodule, configured to, in response to receiving configuration information, locally configure the data of the offline map based on the configuration information.

In some alternative implementations of the present embodiment, the configuring submodule includes: a downloading unit, configured to locate a dependency toolkit of the offline map based on a first preset keyword in the configuration information, and download the dependency toolkit; and a modifying unit, configured to locate a dependency map tile of the offline map based on a second preset keyword in the configuration information, and modify an address of the dependency map tile.

According to an embodiment of the present disclosure, the present disclosure further provides an electronic device, a readable storage medium, and a computer program product.

FIG. 6 illustrates a schematic block diagram of an example electronic device 600 that may be used to implement embodiments of the present disclosure. The electronic device is intended to represent various forms of digital computers, such as laptop computers, desktop computers, workbenches, personal digital assistants, servers, blade servers, mainframe computers, and other suitable computers. The electronic device may also represent various forms of mobile apparatuses, such as personal digital processors, cellular phones, smart phones, wearable devices, and other similar computing apparatuses. The parts shown herein, their connections and relationships, and their functions are merely examples, and are not intended to limit the implementation of the present disclosure described and/or claimed herein.

As shown in FIG. 6, the device 600 includes a computation unit 601, which may perform various appropriate actions and processing, based on a computer program stored in a read-only memory (ROM) 602 or a computer program loaded from a storage unit 608 into a random access memory (RAM) 603. In the RAM 603, various programs and data required for the operation of the device 600 may also be stored. The computation unit 601, the ROM 602, and the RAM 603 are connected to each other through a bus 604. An input/output (I/O) interface 605 is also connected to the bus 604.

A plurality of parts in the device 600 are connected to the I/O interface 605, including: an input unit 606, for example, a keyboard and a mouse; an output unit 607, for example, various types of displays and speakers; the storage unit 608, for example, a disk and an optical disk; and a communication unit 609, for example, a network card, a modem, or a wireless communication transceiver. The communication unit 609 allows the device 600 to exchange information/data with other devices over a computer network such as the Internet and/or various telecommunication networks.

The computation unit 601 may be various general-purpose and/or dedicated processing components having processing and computing capabilities. Some examples of the computation unit 601 include, but are not limited to, central processing unit (CPU), graphics processing unit (GPU), various dedicated artificial intelligence (AI) computing chips, various computation units running machine learning model algorithms, digital signal processors (DSP), and any appropriate processors, controllers, microcontrollers, etc. The computation unit 601 performs the various methods and processes described above, such as the method for automatically downloading a map tile. For example, in some embodiments, the method for automatically downloading a map tile may be implemented as a computer software program, which is tangibly included in a machine readable medium, such as the storage unit 608. In some embodiments, part or all of the computer program may be loaded and/or installed on the device 600 via the ROM 602 and/or the communication unit 609. When the computer program is loaded into the RAM 603 and executed by the computation unit 601, one or more steps of the method for automatically downloading a map tile described above may be performed. Alternatively, in other embodiments, the computation unit 601 may be configured to perform the method for automatically downloading a map tile by any other appropriate means (for example, by means of firmware).

The various implementations of the systems and technologies described herein may be implemented in a digital electronic circuit system, an integrated circuit system, a field programmable gate array (FPGA), an application specific integrated circuit (ASIC), an application specific standard product (ASSP), a system-on-chip (SOC), a complex programmable logic device (CPLD), computer hardware, firmware, software and/or combinations thereof. The various implementations may include: being implemented in one or more computer programs, where the one or more computer programs may be executed and/or interpreted on a programmable system including at least one programmable processor, and the programmable processor may be a particular-purpose or general-purpose programmable processor, which may receive data and instructions from a storage system, at least one input device and at least one output device, and send the data and instructions to the storage system, the at least one input device and the at least one output device.

Program codes used to implement the method of embodiments of the present disclosure may be written in any combination of one or more programming languages. These program codes may be provided to a processor or controller of a general-purpose computer, particular-purpose computer or other programmable data processing apparatus, so that the program codes, when executed by the processor or the controller, cause the functions or operations specified in the flowcharts and/or block diagrams to be implemented. These program codes may be executed entirely on a machine, partly on the machine, partly on the machine as a stand-alone software package and partly on a remote machine, or entirely on the remote machine or a server.

In the context of the present disclosure, the machine-readable medium may be a tangible medium that may include or store a program for use by or in connection with an instruction execution system, apparatus or device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any appropriate combination thereof. A more particular example of the machine-readable storage medium may include an electronic connection based on one or more lines, a portable computer disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any appropriate combination thereof.

To provide interaction with a user, the systems and technologies described herein may be implemented on a computer having: a display device (such as a CRT (cathode ray tube) or LCD (liquid crystal display) monitor) for displaying information to the user; and a keyboard and a pointing device (such as a mouse or a trackball) through which the user may provide input to the computer. Other types of devices may also be used to provide interaction with the user. For example, the feedback provided to the user may be any form of sensory feedback (such as visual feedback, auditory feedback or tactile feedback); and input from the user may be received in any form, including acoustic input, speech input or tactile input.

The systems and technologies described herein may be implemented in: a computing system including a background component (such as a data server), or a computing system including a middleware component (such as an application server), or a computing system including a front-end component (such as a user computer having a graphical user interface or a web browser through which the user may interact with the implementations of the systems and technologies described herein), or a computing system including any combination of such background component, middleware component or front-end component. The components of the systems may be interconnected by any form or medium of digital data communication (such as a communication network). Examples of the communication network include a local area network (LAN), a wide area network (WAN), and the Internet.

Cloud computer refers to a technical system that accesses an elastically scalable shared physical or virtual resource pool through a network, in which resources may include servers, operating systems, networks, software, applications or storage devices, etc., and the resources may be deployed and managed on demand and self-service. Through cloud computing technology, it may provide efficient and powerful data processing capabilities for artificial intelligence, blockchain and other technical applications and model training.

A computer system may include a client and a server. The client and the server are generally remote from each other, and generally interact with each other through the communication network. A relationship between the client and the server is generated by computer programs running on a corresponding computer and having a client-server relationship with each other. The server may be a cloud server, a distributed system server, or a server combined with a blockchain.

It should be appreciated that the steps of reordering, adding or deleting may be executed using the various forms shown above. For example, the steps described in embodiments of the present disclosure may be executed in parallel or sequentially or in a different order, so long as the expected results of the technical schemas provided in embodiments of the present disclosure may be realized, and no limitation is imposed herein.

The above particular implementations are not intended to limit the scope of the present disclosure. It should be appreciated by those skilled in the art that various modifications, combinations, sub-combinations, and substitutions may be made depending on design requirements and other factors. Any modification, equivalent and modification that fall within the spirit and principles of the present disclosure are intended to be included within the scope of the present disclosure.

What is claimed is:

1. A method for automatically downloading a map tile, the method comprising:
determining, in response to determining that a user operates a pre-deployed offline map, a target map tile in an operation process;
judging whether data of the target map tile has been downloaded; and
creating a folder based on attribute information of the target map tile, in response to determining that the data has not been downloaded, and downloading the data of the target map tile automatically to the folder.

2. The method according to claim 1, further comprising:
monitoring whether the user operates the pre-deployed offline map through a map monitoring event.

3. The method according to claim 2, wherein determining the target map tile in the operation process, comprises:
acquiring level information and coordinate information targeted by the operation process based on the map monitoring event; and
determining the target map tile based on the level information and the coordinate information.

4. The method according to claim 3, wherein the method further comprises:
acquiring a download address of the target map tile; and
creating the folder based on attribute information of the target map tile, and downloading the data of the target map tile automatically to the folder, comprises:
storing the level information and the download address using a preset variable;
creating the folder based on the level information; and
downloading the data of the target map tile automatically to the folder based on the download address.

5. The method according to claims 1, wherein the pre-deployed offline map is obtained by deploying through following steps:
acquiring data of the pre-deployed offline map; and
in response to receiving configuration information, locally configuring the data of the pre-deployed offline map based on the configuration information.

6. The method according to claim 5, wherein locally configuring the data of the pre-deployed offline map based on the configuration information, comprises:
locating a dependency toolkit of the pre-deployed offline map based on a first preset keyword in the configuration information, and downloading the dependency toolkit; and
locating a dependency map tile of the pre-deployed offline map based on a second preset keyword in the configuration information, and modifying an address of the dependency map tile.

7. An electronic device, comprising:
at least one processor; and
a memory that stores instructions executable by the at least one processor, and the instructions, when executed by the at least one processor, cause the at least one processor to perform operations, the operations comprising:
determining, in response to determining that a user operates a pre-deployed offline map, a target map tile in an operation process;
judging whether data of the target map tile has been downloaded; and
creating a folder based on attribute information of the target map tile, in response to determining that the data has not been downloaded, and downloading the data of the target map tile automatically to the folder.

8. The electronic device according to claim 7, wherein the operations further comprise:
monitoring whether the user operates the pre-deployed offline map through a map monitoring event.

9. The electronic device according to claim 8, wherein determining the target map tile in a operation process, comprises:
acquiring level information and coordinate information targeted by the operation process based on the map monitoring event; and
determining the target map tile based on the level information and the coordinate information.

10. The electronic device according to claim 9, wherein the operations further comprise:
acquiring a download address of the target map tile; and
creating the folder based on attribute information of the target map tile, and downloading the data of the target map tile automatically to the folder, comprises:
storing the level information and the download address using a preset variable;
creating the folder based on the level information; and
downloading the data of the target map tile automatically to the folder based on the download address.

11. The electronic device according to claims 8, wherein the pre-deployed offline map is obtained by deploying through following steps:
acquiring data of the pre-deployed offline map; and
in response to receiving configuration information, locally configuring the data of the pre-deployed offline map based on the configuration information.

12. The electronic device according to claim 11, wherein locally configuring the data of the pre-deployed offline map based on the configuration information, comprises:
locating a dependency toolkit of the pre-deployed offline map based on a first preset keyword in the configuration information, and downloading the dependency toolkit; and
locating a dependency map tile of the pre-deployed offline map based on a second preset keyword in the configuration information, and modifying an address of the dependency map tile.

13. A non-transitory computer readable storage medium storing computer instructions, wherein, the computer instructions, when executed by at least one processor, cause the at least one processor to perform operations, the operations comprising:
determining, in response to determining that a user operates a pre-deployed offline map, a target map tile in an operation process;
judging whether data of the target map tile has been downloaded; and
creating a folder based on attribute information of the target map tile, in response to determining that the data has not been downloaded, and downloading the data of the target map tile automatically to the folder.

14. The non-transitory computer readable storage medium according to claim 13, wherein the operations further comprise:
monitoring whether the user operates the pre-deployed offline map through a map monitoring event.

15. The non-transitory computer readable storage medium according to claim 14, wherein determining the target map tile in a operation process, comprises:
acquiring level information and coordinate information targeted by the operation process based on the map monitoring event; and
determining the target map tile based on the level information and the coordinate information.

16. The non-transitory computer readable storage medium according to claim 15, wherein the operations further comprise:
acquiring a download address of the target map tile; and
creating the folder based on attribute information of the target map tile, and downloading the data of the target map tile automatically to the folder, comprises:
storing the level information and the download address using a preset variable;
creating the folder based on the level information; and
downloading the data of the target map tile automatically to the folder based on the download address.

17. The non-transitory computer readable storage medium according to claims 13, wherein the pre-deployed offline map is obtained by deploying through following steps:
acquiring data of the pre-deployed offline map; and
in response to receiving configuration information, locally configuring the data of the pre-deployed offline map based on the configuration information.

18. The non-transitory computer readable storage medium according to claim 17, wherein locally configuring the data of the pre-deployed offline map based on the configuration information, comprises:
locating a dependency toolkit of the pre-deployed offline map based on a first preset keyword in the configuration information, and downloading the dependency toolkit; and
locating a dependency map tile of the pre-deployed offline map based on a second preset keyword in the configuration information, and modifying an address of the dependency map tile.
